(19) United States
(12) Patent Application Publication
(10) Pub. No.: US 2017/0274458 A1
(43) Pub. Date: Sep. 28, 2017

(54) Pipe Threading Machine Accessory

(71) Applicant: John Hardman, JR., Tulsa, OK (US)

(72) Inventor: John Hardman, JR., Tulsa, OK (US)

(21) Appl. No.: 15/077,236

(22) Filed: Mar. 22, 2016

(51) Int. Cl. B23B 25/00

(52) U.S. Cl. CPC B23B 25/00

(57) ABSTRACT

A pipe threading machine accessory for utilizing a pipe threading machine to pull wire includes a spindle configured to couple to the pipe threading machine. A puller is positioned through a conduit such that a first end and a second end of the puller protrude from respective opposing ends of the conduit. The first end is configured to couple to the spindle and the second end is configured to couple to a load. The spindle is configured to be rotated by the pipe threading machine such that the puller is spooled around the spindle. The puller and the load attached to the second end of the puller are drawn through the conduit.

### BACKGROUND OF THE DISCLOSURE

### Field of the Disclosure

The disclosure relates to machine accessories and more particularly pertains to a new machine accessory for utilizing a pipe threading machine to pull wire.

### SUMMARY OF THE DISCLOSURE

An embodiment of the disclosure meets the needs presented above by generally comprising a spindle configured to couple to a pipe threading machine. A puller is positioned through a conduit such that a first end and a second end of the puller protrude from respective opposing ends of the conduit. The first end is configured to couple to the spindle and the second end is configured to couple to a load. The spindle is configured to be rotated by the pipe threading machine such that the puller is spooled around the spindle. The puller and the load attached to the second end of the puller are drawn through the conduit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a pipe threading machine accessory according to an embodiment of the disclosure.

FIG. 2 is an end view of an embodiment of the disclosure.

FIG. 3 is a side view of an embodiment of the disclosure.

FIG. 4 is a cross-sectional view of an embodiment of the disclosure.

FIG. 5 is an in-use view of an embodiment of the disclosure.

### DESCRIPTION OF THE PREFERRED EMBODIMENT

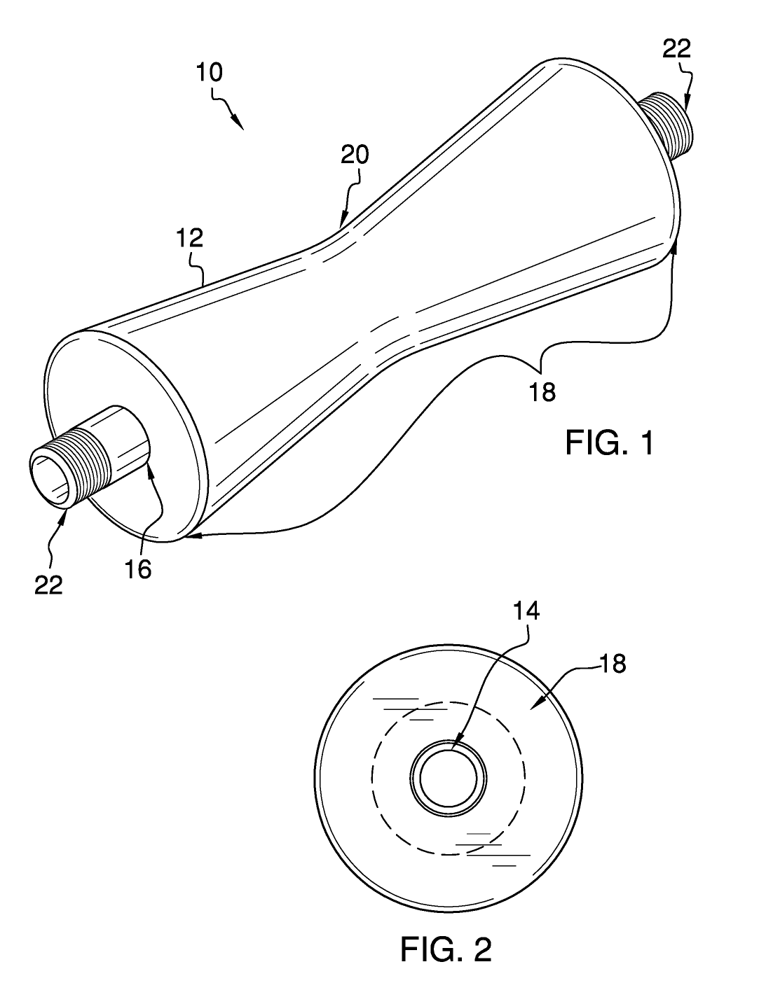

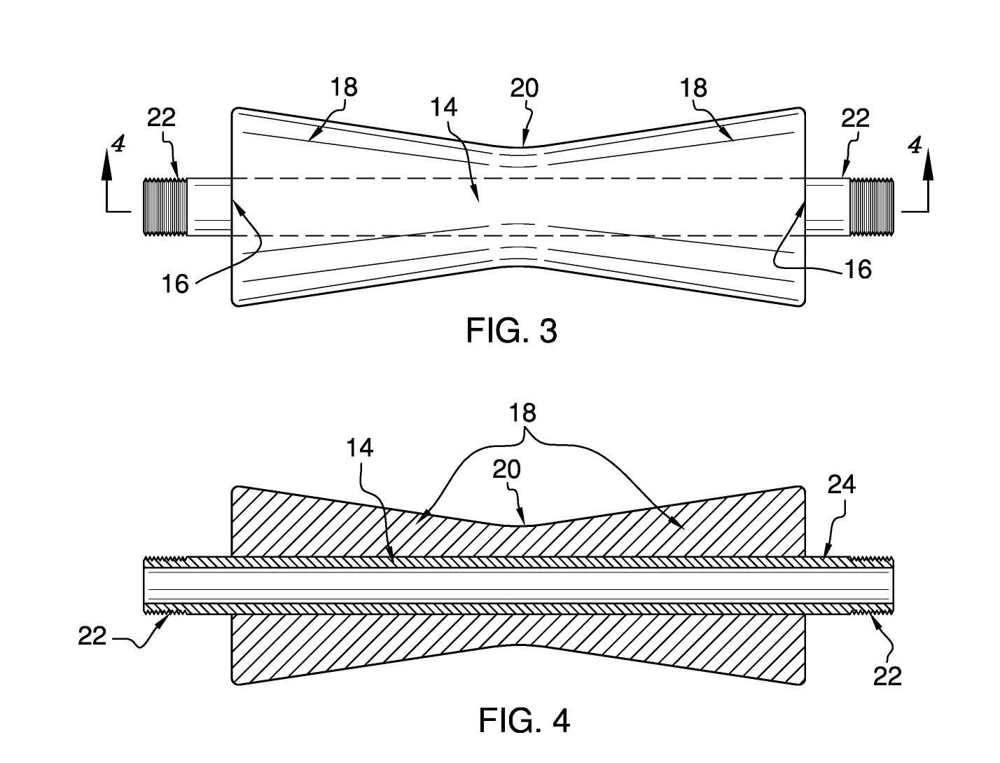

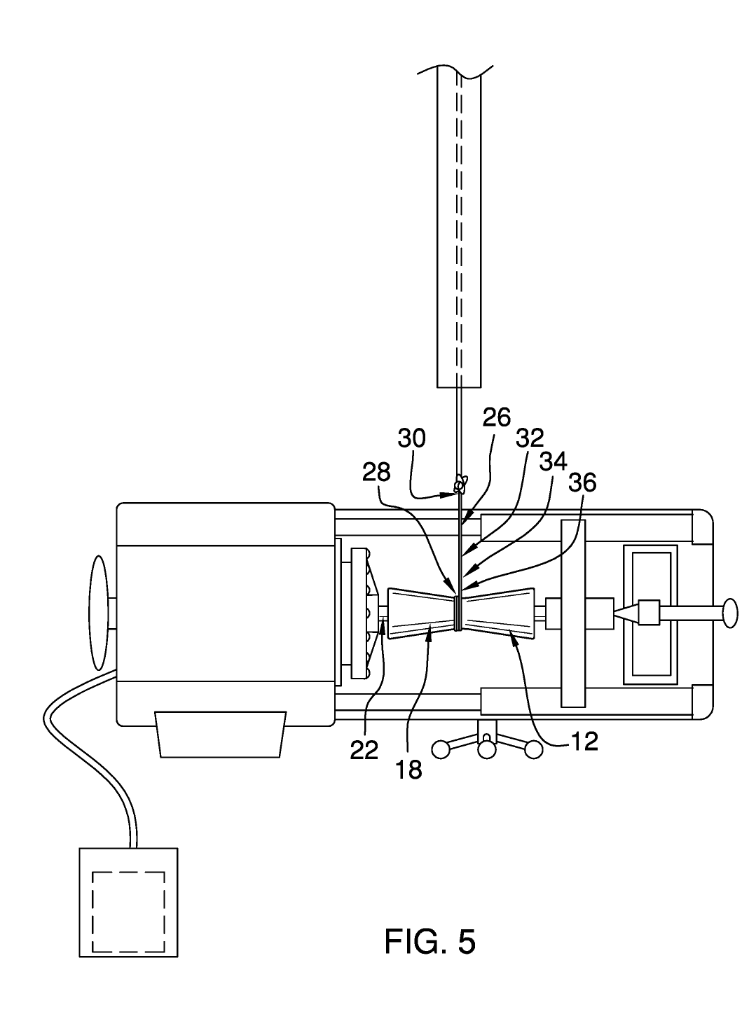

With reference now to the drawings, and in particular to FIGS. 1 through 5 thereof, a new machine accessory embodying the principles and concepts of an embodiment of the disclosure and generally designated by the reference numeral 10 will be described.

As best illustrated in FIGS. 1 through 5, the pipe threading machine accessory 10 generally comprises a spindle 12 that is configured to couple to a pipe threading machine. The spindle 12 comprises a hub 14 that has opposing endpoints 16. The hub 14 is substantially cross-sectionally circularly shaped.

Each of a pair of flanges 18 is coupled to the hub 14 proximate to a respective opposing endpoint 16. The flanges 18 are substantially circularly shaped. Each flange 18 extends angularly toward a center point 20 of the spindle 12, such that each flange 18 is cone-shaped. The flanges 18 may comprise metal. The flanges 18 may comprise aluminum.

Each of a pair of couplers 22 is coupled to and axially positioned on a respective flange 18. The couplers 22 are circular when viewed longitudinally. The couplers 22 are threaded.

In one embodiment, the hub 14 and the couplers 22 together comprise a pipe 24. The pipe 24 may comprise metal. The pipe 24 may comprise steel. The couplers 22 are configured to couple to a pipe threading machine.

A puller 26 is positioned through a conduit such that a first end 28 and a second end 30 of the puller 26 protrude from respective opposing ends of the conduit. The first end 28 is positioned to couple to the spindle 12. The second end 30 is configured to couple to a load. The puller 26 may comprise a string 32. The puller 26 may comprise a rope 34. The puller 26 may comprise a wire 36.

In use, the couplers 22 are configured to couple to a pipe threading machine, such that the spindle 12 is coupled to the pipe threading machine. The spindle 12 is positioned to couple to the first end 28 of the puller 26. The second end 30 of the puller 26 is configured to couple to a load that a user wishes to be pulled through the conduit. The spindle 12 is configured to be rotated by the pipe threading machine such that the puller 26 is spooled around the spindle 12. The flanges 18 are positioned to retain the puller 26 on the hub 14 of the spindle 12. The puller 26 and the load attached to the second end 30 of the puller 26 are drawn through the conduit.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A pipe threading machine conversion system comprising:
a pipe threading machine;
a spindle, said spindle being couplable to said pipe threading machine such that said pipe threading machine rotates said spindle;
a puller positioned through a conduit such that a first end and a second end of said puller protrude from respective opposing ends of the conduit, said first end being positioned to couple to said spindle, said second end being configured to couple to a load;
wherein said spindle is configured to be rotated by the pipe threading machine such that said puller is spooled around said spindle, wherein said puller and the load attached to said second end of said puller are drawn through the conduit.

2. The assembly of claim 1, further including said spindle comprising:
a hub having opposing endpoints;
a pair of flanges, each said flange being coupled to said hub proximate to a respective said opposing endpoint;
a pair of couplers, each said coupler being coupled to and axially positioned on a respective said flange; and
wherein said couplers are configured to couple to a pipe threading machine.

3. The system of claim 2, further including said hub being substantially cross-sectionally circularly shaped.

4. The system of claim 3, further including said flanges being substantially circularly shaped.

5. The system of claim 4, further including each said flange extending angularly toward a center point of said spindle, such that each said flange is cone-shaped.

6. The system of claim 2, further including said flanges comprising metal.

7. The system of claim 6, further including said flanges comprising aluminum.

8. The system of claim 2, further including said couplers being circular when viewed longitudinally.

9. The system of claim 8, further including said couplers being threaded.

10. The system of claim 2, further including said hub and said couplers together comprising a pipe.

11. The system of claim 10, further including said pipe comprising metal.

12. The system of claim 11, further including said pipe comprising steel.

13. The system of claim 1, further including said puller comprising a string.

14. The system of claim 1, further including said puller comprising a rope.

15. The accessory of claim 1, further including said puller comprising wire.

16. A pipe threading machine conversion system comprising:
a pipe threading machine;
a spindle, said spindle being couplable to said pipe threading machine such that said pipe threading machine rotates said spindle, said spindle comprising:
a hub having opposing endpoints, said hub being substantially cross-sectionally circularly shaped,
a pair of flanges, each said flange being coupled to said hub proximate to a respective said opposing endpoint, said flanges being substantially circularly shaped, each said flange extending angularly toward a center point of said spindle, such that each said flange is cone-shaped, said flanges comprising aluminum,
a pair of couplers, each said coupler being coupled to and axially positioned on a respective said flange, said couplers being circular when viewed longitudinally, said couplers being threaded,
said hub and said couplers together comprising a pipe, said pipe comprising steel, and
wherein said couplers are configured to couple to a pipe threading machine;
a puller positioned through a conduit such that a first end and a second end of said puller protrude from respective opposing ends of the conduit, said first end being positioned to couple to said spindle, said second end being configured to couple to a load;
wherein said couplers are configured to couple to a pipe threading machine, wherein said spindle is coupled to the pipe threading machine, such that said spindle is positioned to couple to said first end of said puller, wherein said second end of said puller is configured to couple to a load that a user wishes to be pulled through the conduit, wherein said spindle is configured to be rotated by the pipe threading machine such that said puller is spooled around said spindle, wherein said flanges are positioned to retain said puller on said hub of said spindle, wherein said puller and the load attached to said second end of said puller are drawn through the conduit.
